(19) United States
(12) Patent Application Publication
(10) Pub. No.: US 2013/0065992 A1
(43) Pub. Date: Mar. 14, 2013

(54) Polymer Compositions Containing Oxazine-Based Alkoxysilanes

(71) Applicants: Michael Backer, Mainz (DE); Pierre Chevalier, Lille (FR); Ana Marques, Portela LRS (PT)

(72) Inventors: Michael Backer, Mainz (DE); Pierre Chevalier, Lille (FR); Ana Marques, Portela LRS (PT)

(73) Assignee: DOW CORNING CORPORATION, Midland, MI (US)

(21) Appl. No.: 13/698,806

(22) PCT Filed: May 16, 2011
(86) PCT No.: PCT/EP2011/057896

§ 371 Date: Nov. 19, 2012

(30) Foreign Application Priority Data
May 20, 2010 (GB) GB 1008411.9
Jun. 1, 2010 (GB) GB 1009166.8
May 16, 2011 (EP) PCT/EP2011/057896

(51) Int. Cl. C08K 5/357; C08L 69/00; C08K 3/36

(52) U.S. Cl. 524/87

(57) ABSTRACT

The invention provides a process for improving the fire resistance of a thermoplastic, thermoset or rubber organic polymer composition, characterised in that an alkoxysilane is added to a thermoplastic, thermosetting and rubber organic polymer composition and is heated to cause hydrolysis and condensation of the alkoxysilane. For example the alkoxysilane is a Benzoxazine triethoxysilane.

This invention relates to the use of alkoxysilanes to improve the fire resistance of organic polymer compositions. The invention includes a process for improving the fire resistance of a thermoplastic, thermoset or rubber organic polymer composition, and includes organic polymer compositions containing the alkoxysilanes.

CN-A-1944441 describes benzoxazine-containing silsesquioxanes which can be mixed with epoxy resin, phenolic resin, unsaturated polyester, vinyl polymer, bismaleimide resin, cyanate resin, benzoxazine resin, oxazolinyl resin, polyimides, etc., to form a nanocomposite with improved heat resistance.

The paper ‘Synthesis of benzoxazine functional silane and adhesion properties of glass fibre reinforced polybenzoxazine composites’ by H. Ishida et al in J. Applied Polymer Science (1998), 69, 2559-2567 describes the synthesis of a benzoxazine functional alkoxysilane and its use to treat glass fibres which are then incorporated in glass fibre reinforced polybenzoxazine composites.

The paper ‘Polybenzoxazine containing polysilsesquioxane: preparation and thermal properties’ by Longhong Liu et al. in J. Applied Polymer Science (2006), 99(3), 927-936 describes synthesis of a benzoxazine bearing trimethoxysilane and its hydrolysis and condensation to a sol polysilsesquioxane bearing benzoxazine groups. By initiating the occurring reaction of this polysilsesquioxane with difunctional benzoxazine of bisphenol A, the inorganic-organic hybrids of polybenzoxazine with polysilsesquioxane exhibiting improved thermal stability were prepared.

Due to the widespread and increasing use of synthetic polymers, there are a large number of flame retardant compounds in use in today's plastic markets. Halogen containing flame retardants have performed well in terms of flame retardancy properties, processability, cost, etc, however there is an urgent need for halogen-free flame retardants (HFFR) as polymer additives, which comply with environmental regulations, OEM perception, customers requirements, etc. Fire safety is now based on preventing ignition and reducing flame spread through reducing the rate of heat release, as well as on reducing fire toxicity. Flame retardant additives must be safe in what concerns health and environment, must be cost efficient and maintain/improve plastics performance.

The halogenated flame retardant compounds act mostly in the vapour phase by a radical mechanism to interrupt the exothermic processes and to suppress combustion. Examples are the bromine compounds, such as tetrabromobisphenol A, chlorine compounds, halogenated phosphate ester, etc.

Among the halogen-free flame retardants one can find the metal hydroxides, such as magnesium hydroxide (Mg(OH)₂) or aluminum hydroxide (Al(OH)₃), which act by heat absorbance, i.e. endothermic decomposition into the respective oxides and water when heated, however they present low flame retardancy efficiency, low thermal stability and significant deterioration of the physical/chemical properties of the matrices. Other compounds act mostly on the condensed phase, such as expandable graphite, organic phosphorous (e.g. phosphate, phosphonates, phosphine, phosphine oxide, phosphonium compounds, phosphites, etc.), ammonium polyphosphate, etc. Zinc borate, nanoclays and red phosphorous are other examples of halogen-free flame retardants. Silicon-containing additives are known to significantly improve the flame retardancy, acting both through char formation in the condensed phase and by the trapping of active radicals in the vapour phase. Sulfur-containing additives, such as potassium diphenylsulfone sulfonate (KSS), are well known flame retardant additives for thermoplastics, in particular for polycarbonate.

Either the halogenated, or the halogen-free compounds can act by themselves, or as synergetic agent together with the compositions claimed in the present patent to render the desired flame retardance performance to many polymer matrices. For instance, phosphonate, phosphine or phosphine oxide have been referred in the literature as being anti-dripping agents and can be used in synergy with the flame retardant additives disclosed in the present patent. The paper “Flame-retardant and anti-dripping effects of a novel char-forming flame retardant for the treatment of poly(ethylene terephthalate) fabrics” presented by Dai Qi Chen et al. at 2005 Polymer Degradation and Stability describes the application of a phosphonate, namely poly(2-hydroxy propylene spirocyclic pentaerythritol bisphosphonate) to impart flame retardance and dripping resistance to poly(ethylene terephthalate) (PET) fabrics. Benzoguanamine has been applied to PET fabrics to reach anti-dripping performance as reported by Hong-yan Tang et al. at 2010 in “A novel process for preparing anti-dripping PET fibres”, Materials & Design. The paper “Novel Flame-Retardant and Anti-dripping Branched Polyesters Prepared via Phosphorus-Containing Ionic Monomer as End-Capping Agent” by Jun-Sheng Wang et al. at 2010 reports on a series of novel branched polyester-based ionomers which were synthesized with trihydroxy ethyl esters of trimethyl-1,3,5-benzentricarboxylate (as branching agent) and sodium salt of 2-hydroxyethyl 3-(phenylphosphinyl)propionate (as end-capping agent) by melt polycondensation. These flame retardant additives dedicated to anti-dripping performance can be used in synergy with the flame retardant additives disclosed in this patent. Additionally, the flame retardant additives disclosed in the present patent have demonstrated synergy with other well-known halogen-free additives, such as KSS.

In a process according to the invention for improving the fire resistance of a thermoplastic, thermoset or rubber organic polymer composition, an alkoxysilane of the formula

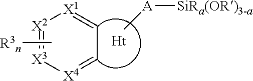

where X¹, X², X³ and X⁴ independently represent a CH group or a N atom and form a benzene, pyridine, pyridazine, pyrazine, pyrimidine or triazine aromatic ring; Ht represents a heterocyclic ring fused to the aromatic ring and comprising 2 to 8 carbon atoms, 1 to 4 nitrogen atoms and optionally 1 or 2 oxygen and/or sulphur atoms; A represents a divalent organic linkage having 1 to 20 carbon atoms bonded to a nitrogen atom of the heterocyclic ring; each R represents an alkyl, cycloalkyl, alkenyl, alkynyl, aryl, aminoalkyl or aminoaryl group having 1 to 20 carbon atoms; each R′ represents an alkyl group having 1 to 4 carbon atoms; a is 0, 1 or 2; the heterocyclic ring can optionally have one or more substituent groups selected from alkyl, substituted alkyl, cycloalkyl, alkenyl, alkynyl, aryl and substituted aryl groups having 1 to 12 carbon atoms and amino, nitrile, amido and imido groups; and R³ₙ, with n=0-4, represents an alkyl, substituted alkyl, alkenyl group having 1 to 8 carbon atoms or cycloalkyl, alkynyl, aryl, substituted aryl groups having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, substituted on one or more positions of the aromatic ring, or two groups R³ can be joined to form a ring system comprising at least one carbocyclic or heterocyclic ring annelated to the aromatic ring;
is added to a thermoplastic, thermosetting or rubber organic polymer composition and is heated to cause hydrolysis and condensation of the alkoxysilane.

The invention includes the use of an alkoxysilane as defined above to improve the fire resistance of a thermoplastic, thermoset or rubber organic polymer composition. The invention also includes a polymer composition comprising a thermoplastic, thermosetting or rubber organic polymer and an alkoxysilane as defined above.

Polyorganosiloxanes, also known as silicones, generally comprise siloxane units selected from R₃SiO_{1/2} (M units), R₂SiO_{2/2}(D units), RSiO_{3/2}(T units) and SiO_{4/2}(Q units), in which each R represents an organic group or hydrogen or a hydroxyl group. Q units can be formed by hydrolysis and siloxane condensation of a tetraalkoxysilane. T units can be formed by hydrolysis and condensation of a trialkoxysilane. D units can be formed by hydrolysis and condensation of a dialkoxysilane. M units can be formed by hydrolysis and condensation of a monoalkoxysilane. Branched silicone resins contain T and/or Q units, optionally in combination with M and/or D units.

It is preferred that the polysiloxane which is formed within the thermoplastic, thermosetting or rubber organic polymer composition when the polymer composition is heated to cause hydrolysis and condensation of the alkoxysilane is a branched silicone resin. According to one aspect of the invention it is preferred that the alkoxysilane containing a heterocyclic group is a trialkoxysilane, which will form T units on hydrolysis and condensation. Alternatively the alkoxysilane containing a heterocyclic group can be a dialkoxysilane or monoalkoxysilane if it is used in conjunction with a tetraalkoxysilane or trialkoxysilane.

The alkoxysilane containing a heterocyclic group is preferably a trialkoxysilane of the formula

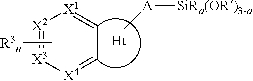

where X¹, X², X³ and X⁴, Ht, A, R, R′, a, R3, and n are defined as above.

The heterocyclic ring Ht is preferably not a fully aromatic ring, i.e. it is preferably not a pyridine, pyridazine, pyrazine, pyrimidine or triazine aromatic ring. The heterocyclic ring Ht can for example be an oxazine, pyrrole, pyrroline, imidazole, imidazoline, thiazole, thiazoline, oxazole, oxazoline, isoxazole or pyrazole ring. Examples of preferred heterocyclic ring systems include benzoxazine, indole, benzimidazole, benzothiazole and benzoxazole. In some preferred alkoxysilanes the heterocyclic ring is an oxazine ring; such alkoxysilanes have the formula

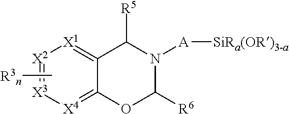

where X¹, X², X³ and X⁴, Ht, A, R, R′, a, R³ and n are defined as above and R⁵ and R⁶ each represent hydrogen, an alkyl, substituted alkyl, cycloalkyl, alkenyl, alkynyl, aryl or substituted aryl group having 1 to 12 carbon atoms, or an amino or nitrile group. The alkoxysilane can for example be a substituted benzoxazine of the formula

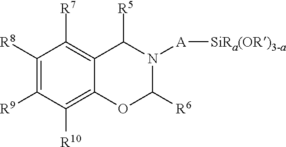

where R⁷, R⁸, R⁹ and R¹⁰ each represent hydrogen, an alkyl, substituted alkyl, alkenyl group having 1 to 8 carbon atoms or cycloalkyl, alkynyl, aryl, substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms; R⁷ and R⁸, R⁸ and R⁹ or R⁹ and R¹⁰ can each be joined to form a ring system comprising at least one carbocyclic or heterocyclic ring fused to the benzene ring.

Examples of useful trialkoxysilanes containing a heterocyclic group thus include 3-(3-benzoxazinyl)propyltriethoxysilane

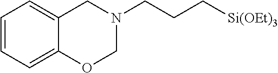

and the corresponding naphthoxazinetriethoxysilane,

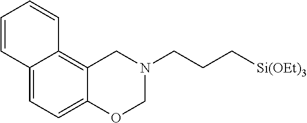

3-(6-cyanobenzoxazinyl-3)propyltriethoxysilane,

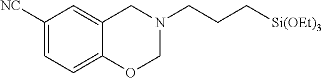

and 3-(2-phenylbenzoxazinyl-3)propyltriethoxysilane

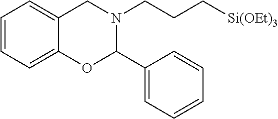

The oxazine or other heterocyclic ring Ht can alternatively be bonded to a pyridine ring to form a heterocyclic group of the formula

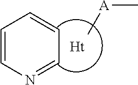

Alternative alkoxysilanes containing a heterocyclic group are monoalkoxysilanes containing a group of the formula —R₂SiOR′ and dialkoxysilanes containing a group of the formula —RSi(OR′)₂ where R and R′ are defined as above. An example of a suitable monoalkoxysilane is 3-(3-benzoxazinyl)propyldimethylethoxysilane. An example of a suitable dialkoxysilane is 3-(3-benzoxazinyl)propylmethyldiethoxysilane. If a monoalkoxysilane or dialkoxysilane containing a heterocyclic group is used in the present invention, it is preferably added to the thermoplastic, thermosetting or rubber organic polymer composition together with at least one trialkoxysilane and/or tetraalkoxysilane so that when the alkoxysilanes are hydrolysed they will condense to form a branched silicone resin within the polymer composition.

The benzene, pyridine, pyridazine, pyrazine or triazine aromatic ring can be annelated to a ring system comprising at least one carbocyclic or heterocyclic ring to form an extended ring system enlarging the pi-electron conjugation. A benzene ring can for example be annelated to another benzene ring to form a ring system containing a naphthanene moiety

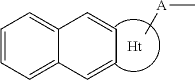

such as a naphthoxazine group, or can be annelated to a pyridine ring to form a ring system containing a quinoline moiety.

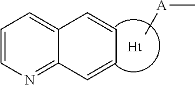

A pyridine ring can for example be annelated to a benzene ring to form a ring system containing a quinoline moiety in which the heterocyclic ring Ht, for example an oxazine ring, is fused to the pyridine ring

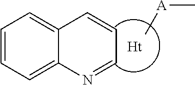

The aromatic ring can be annelated to a quinone ring to form a benzoquinoid or naphthoquinoid structure. In an alkoxysilane of the formula

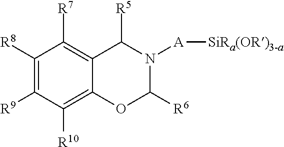

the groups R⁸ and R⁹, R⁷ and R⁸, or R⁹ and R¹⁰ can form an annelated ring of benzoquinoid or naphthoquinoid structure. Such ring systems containing carbonyl groups may have improved solubility in organic solvents, allowing easier application to polymer compositions.

The alkoxysilane can be a bissilane containing two heterocyclic rings each having an alkoxysilane substituent. The heterocyclic rings can for example each be bonded to separate aromatic rings which are chemically bonded to each other. The aromatic rings can for example be bonded by a direct bond

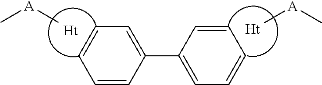

or can be bonded by a divalent organic group

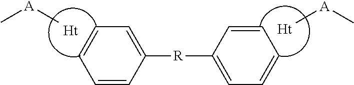

For example in an alkoxysilane of the formula

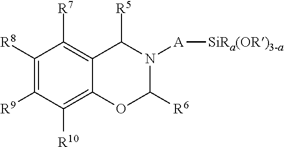

where A, R, R′, a, R⁵ and R⁶ are each defined as above, one group selected from R⁷, R⁸, R⁹ and R¹⁰ represents an alkyl group substituted by a group of the formula

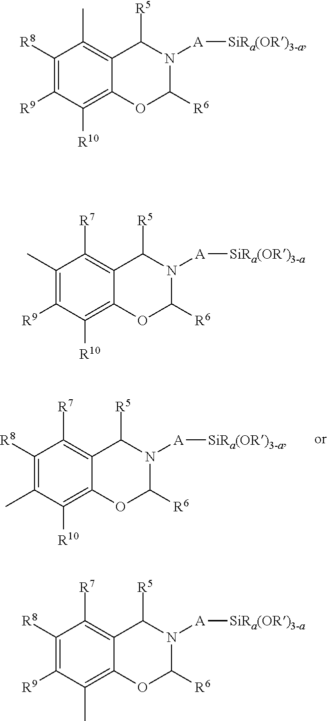

where A, R, R′, a, R⁵ and R⁶ are each defined as above. The remaining groups of R⁷, R⁸, R⁹ and R¹⁰ in each ring can each represent hydrogen, an alkyl, substituted alkyl, alkenyl group having 1 to 8 carbon atoms or cycloalkyl, alkynyl, aryl, substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms; An example of such a bissilane is 1,3-bis(3-(3-trimethoxysilylpropyl)benzoxazinyl-6)-2,2-dimethylpropane

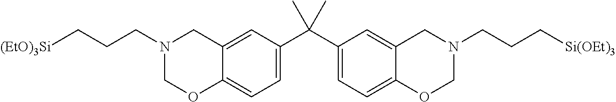

The heterocyclic rings Ht, for example oxazine rings, in a bissilane can alternatively both be fused to the same aromatic ring

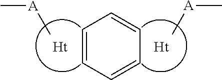

The aromatic ring can optionally be annelated to a further ring system comprising at least one carbocyclic or heterocyclic ring

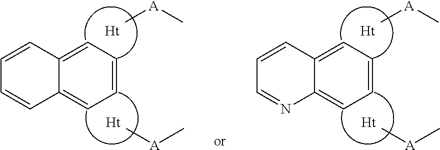

The heterocyclic rings Ht having a -A-SiRₐ(OR′)₃₋ₐ substituent can be fused to different rings of an annelated aromatic ring system such as quinoline or naphthalene

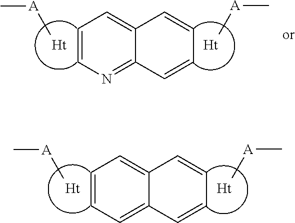

A bissilane can have heterocyclic rings, each having a -A-SiRₐ(OR′)₃₋ₐ substituent, fused to the same aromatic ring of an annelated benzoquinoid or naphthoquinoid structure, for example

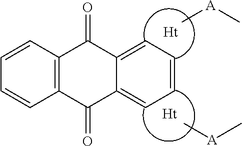

In a naphthoquinoid structure the heterocyclic rings, each having a -A-SiRₐ(OR′)₃₋ₐ substituent, can be fused to the first and second rings of the naphthoquinoid structure

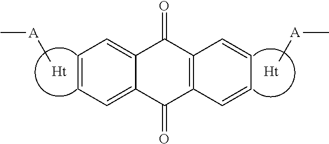

The alkoxysilane containing a heterocyclic group can optionally be added to the thermoplastic, thermosetting or rubber organic polymer composition in conjunction with a tetraalkoxysilane and/or a trialkoxysilane which does not contain a heterocyclic group. A tetraalkoxysilane may have the formula Si(OR′)₄ where each R′ is an alkyl group having 1 to 4 carbon atoms. An example of a useful tetraalkoxysilane is tetraethoxysilane. A trialkoxysilane may have the formula RSi(OR′)₃, in which each R′ is an alkyl group having 1 to 4 carbon atoms and R represents an alkyl, cycloalkyl, aminoalkyl, alkenyl, alkynyl, aryl or aminoaryl group having 1 to 20 carbon atoms. Examples of useful trialkoxysilanes of the formula RSi(OR′)₃ are alkyltrialkoxysilanes such as methyltriethoxysilane, ethyltriethoxysilane, methyltrimethoxysilane and aryltrialkoxysilanes such as phenyltriethoxysilane. The tetraalkoxysilane and/or trialkoxysilane which does not contain a heterocyclic group can for example be present at 0 to 500% by weight based on the alkoxysilane containing a heterocyclic group.

The alkoxysilane(s) can for example be added to a thermoplastic, thermoset or rubber organic polymer composition according to the invention in amounts ranging from 0.1 or 0.5% by weight total alkoxysilane(s) up to 50 or 75%. Preferred amounts may range from 0.1 to 25% by weight alkoxysilane(s) in thermoplastic compositions such as polycarbonates, and from 0.2 to 75% by weight alkoxysilane(s) in thermosetting compositions such as epoxy resins.

The alkoxysilane(s) is heated in the presence of thermoplastic, thermosetting or rubber organic polymer composition and in the presence of moisture or hydroxyl groups to cause hydrolysis and condensation of the alkoxysilane or alkoxysilanes. It is generally not necessary to deliberately add moisture to achieve hydrolysis. Atmospheric moisture is often sufficient to cause hydrolysis of the alkoxysilane(s). Moisture present in the organic polymer, for example on the surface of thermoplastic polymer particles such as polycarbonate pellets, is often sufficient. If the polymer composition contains a filler such as silica, moisture or hydroxyl groups present at the surface of the filler is generally sufficient for hydrolysis. Alternatively water can be added with the alkoxysilane(s). Water can for example be added in an approximately stoichiometric amount with respect to the Si-bonded alkoxy groups of the alkoxysilane(s), for example 0.5 to 1.5 moles water per alkoxy group.

Heating can be carried out simultaneously with the addition of the alkoxysilane(s) or subsequent to the addition of the alkoxysilane(s). In a preferred process, mixing with the thermoplastic, thermosetting or rubber organic polymer composition takes place at an elevated temperature above the glass transition temperature of the polymer and preferably above the softening temperature of the polymer. Mixing can for example take place at a temperature in the range 50 to 300° C. Mixing can for example be carried out continuously in an extruder, which can be an extruder adapted to knead or compound the materials passing through it such as a twin screw extruder or can be a more simple extruder such as a single screw extruder. A batch mixing process can for example be carried out in an internal mixer such as a Brabender Plastograph (Trade Mark) 350S mixer equipped with roller blades, or a Banbury mixer. A roll mill can be used for either batch or continuous processing.

We believe that when an alkoxysilane containing at least one heterocyclic group is heated, optionally with another alkoxysilane, in a thermoplastic, thermosetting or rubber organic polymer composition in the presence of moisture to cause hydrolysis and condensation of the alkoxysilane or alkoxysilanes, a silicone resin containing heterocyclic groups is formed within the organic polymer composition. We have found that the polymer compositions to which the alkoxysilanes have been added have improved thermal stability, as shown by thermogravimetric (TGA) analysis, and better flame retardancy properties, as shown by TGA and the UL-94 test, or other flammability tests such as the glow wire test or cone calorimetry.

The alkoxysilane can be incorporated according to the invention into a wide range of thermoplastic resins, for example polycarbonates, ABS (acrylonitrile butadiene styrene) resins, polycarbonate/ABS blends, polyesters, polystyrene, or polyolefins such as polypropylene or polyethylene. The alkoxysilane can also be incorporated into thermosetting resins, for example epoxy resins of the type used in electronics applications, which are subsequently thermoset, or unsaturated polyester resins. The alkoxysilane can also be incorporated into rubbers such as natural or synthetic rubbers. The alkoxysilane containing a heterocyclic group is particularly effective in increasing the fire resistance of polycarbonates and blends of polycarbonate with other resins such as polycarbonate/ABS blends. Such polycarbonates and blends are moulded for use in, for example, the interior of transportation vehicles, in electrical applications as insulators and in construction. Unsaturated polyester resins, or epoxy are moulded for use in, for example, the nacelle of wind turbine devices. Normally, they are reinforced with glass (or carbon) fibre cloth, however, the use of a flame retardant additive is important for avoiding fire propagation.

The polymer compositions of the invention can alternatively be used as a fire resistant coating. Such coatings can be applied to a wide variety of substrates including plastics, textiles, paper, metal and wood substrates, for example structural elements such as walls, columns, girders and lintels which may be exposed to a fire. For use in coatings the thermoplastic, thermosetting or rubber organic polymer is preferably a film-forming binder such as an epoxy resin, a polyurethane or an acrylic polymer. The silanes of the invention can alternatively be used as a fire resistant coating. Such silanes can be applied by dip-, spin-, spray-coating, etc. on a wide variety of substrates (plastics, textiles, metal, wood, cork, etc.), or as fibre sizing agents, or in filler (aluminum tetrahydrate, ATH, magnesium dihydrate, MDH) treatment, or in carbon nanotube functionalisation, etc. Additionally, these silanes can be employed as silane coupling agents on carbon, glass or other types of substrates, such as, but not limited to fibres to be used in composites containing thermoplastics, thermosets or rubbers. These silanes lead to the improvement of interfacial adhesion, which could be measured by the interlaminar shear strength, leading to improved performances such as thermal and mechanical durability for an enhanced reliability of the final composite. One of the mechanisms is limiting the water pick-up of the substrate through for instance further curing by ring-opening polymerization. Atmospheric moisture is often sufficient to cause hydrolysis of the alkoxysilane(s), or water, other OH species or OH releasing groups can be added to the alkoxysilane prior to the coating process. Hydrolysis and condensation reactions may be promoted at that stage by adding a catalyst, such as an acid or base, and/or by heating the silane solution to 20-70° C. The sol-gel method can be employed in this case.

The polymer compositions of the invention can contain additives such as fillers, pigments, resins, dyes, plasticisers, adhesion promoters, coupling agents, antioxidants, impact resistants, hardeners (e.g. for anti-scratch) and/or light stabilisers.

In particular the polymer compositions of the invention can contain a reinforcing filler such as silica. The silica is preferably blended with the alkoxysilane before the alkoxysilane is added to the thermoplastic, thermoset or rubber organic polymer composition. When the alkoxysilane is heated with the silica in the thermoplastic, thermoset or rubber organic polymer composition, some bonding may take place between the alkoxysilane and the silica. The silica can for example be present at 0.1 or 0.5% by weight up to 40 or 60% by weight of the thermoplastic, thermoset or rubber organic polymer composition, and can be present at 1 to 500% based on the weight of alkoxysilane.

The polymer compositions of the invention can contain a preformed silicone resin, for example a branched silicone resin such as a T resin. The silicone resin is preferably blended with the alkoxysilane before the alkoxysilane is added to the thermoplastic, thermoset or rubber organic polymer composition. The alkoxysilane may react with the silicone resin as it hydrolyses and condenses to form a branched silicone resin derived from both the alkoxysilane and the silicone resin within the polymer composition.

The polymer compositions of the invention can contain a silicone gum, that is a high molecular weight substantially linear polydiorganosiloxane. The silicone gum can for example be a polydimethylsiloxane of viscosity at least 60,000 centiStokes at 25° C., particularly above 100,000 cSt at 25° C., and may have a viscosity as high as 30,000,000 cSt at 25° C. The silicone gum is preferably blended with the alkoxysilane before the alkoxysilane is added to the thermoplastic, thermoset or rubber organic polymer composition. The silicone gum can for example be present at 0.1 or 0.5% by weight up to 20 or 30% by weight of the thermoplastic, thermoset or rubber organic polymer composition, and can be present at 1 to 100% by weight based on the alkoxysilane. The silicone gum acts as a plasticiser for the silicone resin formed by hydrolysis and condensation of the alkoxysilane and may increase the flexural strength of the resulting polymer compositions.

If silica is incorporated in compositions comprising the alkoxysilanes as described above, it can be gum-coated silica. An example of gum-coated silica is sold by Dow Corning under the trademarks DC4-7051 and DC4-7081 as a resin modifier for silicone resins.

The invention is illustrated by the following Examples, in which parts and percentages are by weight.

### EXAMPLE 1

### Synthesis of Benzoxazine Triethoxysilane

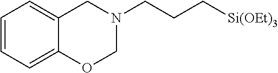

15,015 g of paraformaldehyde (500 mmole of H2C═O), 17.75 g of sodium sulfate powder (125 mmole) and 100 ml ethanol were charged to a 1 litre 3-necked flask and stirred (magnetic stirrer). 55,343 g of aminopropyltriethoxysilane, APTES, sold by Dow Corning under the trade mark DC Z-6011 (250 mmole) were weighed with 100 ml of ethanol into a dropping funnel and added under vigorous stirring to the formaldehyde solution at room temperature (exothermic). The mixture was then heated to around 60 degrees C. for 10 minutes. Then 23.63 g of phenol in 200 ml ethanol were added dropwise over about 1 h. Then the complete mixture was heated up to reflux temperature of ethanol and stirred for 5 hours. The ethanol was stripped off by rotary evaporation.

3.24 g of the benzoxazine silane prepared above was added to 300 g of polycarbonate in an internal mixer compounder at 270° C. The residence time in the mixer was 8 minutes. The composition obtained was pressed in a hot press machine at 250° C. and 100 MPa.

The composition of Example 1 was subjected to conventional thermogravimetric analysis in which the sample was heated to 950° C. at a heating rate of 10° C. per minute. The residue remaining at 950° C. was 8.16%, indicating formation of some ceramic char. By comparison, a sample of the polycarbonate without the silane additive had a residue of 1.24% at 950° C.

The composition of Example 1 was also subjected to flash thermogravimetric analysis in which the sample was heated to 500° C. at a heating rate of 300° C. per minute and held at 500° C. for 20 minutes. This test simulates exposure of the composition to a fire. The residue remaining after 20 minutes at 500° C. was 38.4%, indicating formation of a considerable amount of char. By comparison, a sample of the polycarbonate without the silane additive had a residue of 11.7% after 20 minutes at 500° C.

### EXAMPLE 2

DEN 438 (novolak epoxy resin without bromine, 85% solid resin, from Dow Chemicals) was mixed with dicyandiamide at 2.4% and 2-methylimidazole at 0.44%. To this mixture was added 13% of the benzoxazine silane prepared in Example 1. The composition was placed in an Al dish and cure at 190° C. for 1 h 30 min (with heating and cooling rate at 3° C./min). The resulting cured composition had a glass transition temperature Tg of 189° C., a Si content of 0.95% and a N content of 0.47%.

A 0.7 mm. thick sheet was prepared from the cured epoxy composition and was subjected to the UL-94 Vertical Burn test in which a flame is applied to the free end of a 120 mm×12 mm sample. The sample was self-extinguishing with a flaming time (t1) of 15 seconds (compared to 35 seconds for the epoxy reference sample) and did not exhibit dripping.

### COMPARATIVE EXAMPLES

In Comparative Example Cl, Example 2 was repeated replacing the benzoxazine silane by the same weight of benzoxazine monomer. The sample was self-extinguishing with a flaming time of 18 seconds. It can be seen that the benzoxazine silane of Example 2 gave a flame retardance performance which was significantly better (shorter flaming time) than for comparative example C1.

### EXAMPLE 2A

DEN 438 (novolak epoxy resin without bromine, 85% solid resin, from Dow Chemicals) was mixed with dicyandiamide at 2.4% and 2-methylimidazole at 0.44%. To this mixture was added 13% of the benzoxazine silane prepared in Example 1. The composition was placed in an Al dish and cured at 190° C. for 1 h 30 min (with heating and cooling rate at 3° C./min). The resulting cured composition had a glass transition temperature Tg of 189° C., a Si content of 0.95% and a N content of 0.47%.

A 120×12×2 mm. plate was prepared from the cured epoxy composition and was subjected to the UL-94V Vertical Burn test. The sample was self-extinguishing with a flaming time of 26 seconds and did not exhibit dripping. By comparison, the same epoxy composition cured without the benzoxazine silane exhibited dripping in this UL-94V test, and had a flaming time of 35 seconds.

The composition of Example 2A was also heated at 960° C. using the apparatus described in the IEC 60695-2-12 glow wire flammability index test. A test specimen is held for 30 seconds against the tip of the glow wire with a force of 1 N. After the glow wire is removed, the height of the flames and the time for the flames to extinguish is noted. This test is used to simulate the effect of heat as may arise in malfunctioning electrical equipment, such as with overloaded or glowing components. The flame extinction time was 18 seconds and the flame height was 5 mm. By comparison, the same epoxy composition cured without the benzoxazine silane had a flame extinction time of 60 seconds and a flame height of 60 mm in this glow wire test.

### EXAMPLES 3 TO 6

Example 1 was repeated replacing the benzoxazine silane by the same weight of each of the substituted benzoxazine silanes whose synthesis is described below

### EXAMPLE 3

### Synthesis of Naphthoxazine EthoxySilane

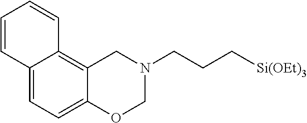

15.015 g of paraformaldehyde (500 mmole of H2C═O), 17.75 g of sodium sulfate powder (125 mmole) and 100 ml ethanol were charged to a 1 litre 3-necked flask and stirred (magnetic stirrer). 55.343 g of APTES (250 mmole) was weighed with 100 ml of ethanol into a dropping funnel and added under vigorous stirring to the formaldehyde solution at room temperature (exothermic). The mixture was then heated to around 60 degrees C. for 10 minutes. Then 36.043 g of 2-naphthol (250 mmole) in 200 ml ethanol was added dropwise over about 1 h. Then the complete mixture was heated up to reflux temperature of ethanol and stirred for 5 hours. The ethanol was stripped off by rotary evaporation.

### EXAMPLE 4

### Synthesis of Cyano Benzoxazine EthoxySilane

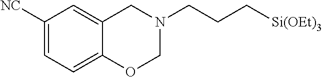

15,015 g of paraformaldehyde (500 mmole of H2C═O), 17.75 g of sodium sulfate powder (125 mmole) and 100 ml ethanol were charged to a 1 litre 3-necked flask and stirred (magnetic stirrer). 55,343 g of APTES (250 mmole) was weighed with 100 ml of ethanol into a dropping funnel and added under vigorous stirring to the formaldehyde solution at room temperature (exothermic). The mixture was then heated to around 60 degrees C. for 10 minutes. Then 29,780 g of cyanophenol (250 mmole) in 200 ml ethanol was added dropwise over about 1 h. Then the complete mixture was heated up to reflux temperature of ethanol and stirred for 5 hours. The ethanol was stripped off by rotary evaporation.

### EXAMPLE 5

### Synthesis of Bis-Benzoxazine Bis-EthoxySilane

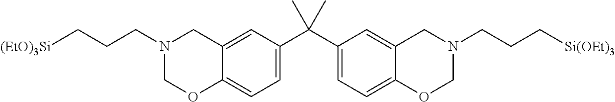

15.015 g of paraformaldehyde (500 mmole of H2C═O), 17.75 g of sodium sulfate powder (125 mmole) and 100 ml ethanol were charged to a 1 litre 3-necked flask and stirred (magnetic stirrer). 55.343 g of APTES (250 mmole) was weighed with 100 ml of ethanol into a dropping funnel and added under vigorous stirring to the formaldehyde solution at room temperature (exothermic). The mixture was then heated to around 60 degrees C. for 10 minutes. Then 28.536 g of bisphenol A (125 mmole) in 200 ml ethanol was added dropwise over about 1 h. Then the complete mixture was heated up to reflux temperature of ethanol and stirred for 5 hours. The ethanol was stripped off by rotary evaporation.

### EXAMPLE 6

### Synthesis of Phenyl Benzoxazine EthoxySilane

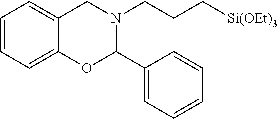

7,507 g of paraformaldehyde (250 mmole of H2C═O), 26,530 g of benzaldehyde (250 mmole), 17.75 g of sodium sulfate powder (125 mmole) and 100 ml ethanol were charged to a 1 litre 3-necked flask and stirred (magnetic stirrer). 55,343 g of APTES (250 mmole) was weighed with 100 ml of ethanol into a dropping funnel and added under vigorous stirring to the formaldehyde solution at room temperature (exothermic). The mixture was then heated to around 60 degrees C. for 10 minutes. Then 23.63 g of phenol in 200 ml ethanol was added dropwise over about 1 h. Then the complete mixture was heated up to reflux temperature of ethanol and stirred for 5 hours. The ethanol was stripped off by rotary evaporation.

### EXAMPLES 7 TO 10

Example 2 was repeated replacing the benzoxazine silane by the same weight in Examples 7 to 10 respectively of each of the substituted benzoxazine silanes whose synthesis is described in Examples 3 to 6 above.

### EXAMPLE 11

### Preparation of 4-Methoxy-Benzoxazine triethoxysilane

A 1 L flask fitted with a nitrogen valve, condenser and dropping funnel was purged with nitrogen. A portion of paraformaldehyde (30.03 g, 1 mole) in ethanol (200 ml) was charged to the reaction flask and stirred. The dropping funnel was then charged with aminopropyltriethoxysilane Z-6011 (110.69) in ethanol (100 ml) before adding the solution dropwise to the reaction flask at room temperature over a period of around 30 min. Once the addition of the aminopropyltriethoxysilane was complete (slight exotherm reaction) another 200 ml of ethanol were added and the reaction temperature was raised to 65° C. 4-Methoxyphenol (62.07 g, 500 mmole) in ethanol (250 ml) was then charged to the dropping funnel and the mixture was added dropwise to the flask. The reaction was stirred at 65° C. for around 4 hours. Hereby the slightly milky solution completely cleared up. Once the mixture was cooled down the solvent was stripped off using a rotary evaporator ensuring that the heating bath temperature does not increase above 45° C. 185-187 g of a viscous, slightly yellow liquid were received.

### EXAMPLE 12

### Preparation of PC+0.65 wt % Methoxy Benzoxazine Silane+0.4 wt % KSS

2.09 g of the methoxy benzoxazine silane prepared in Example 11 was added to 319.5 g of polycarbonate, together with 1.28 g of potassium diphenylsulfone sulfonate (KSS), in an internal mixer compounder at 270° C. The residence time in the mixer was 8 minutes. The composition obtained was pressed in a hot press machine at 250° C. and 100 MPa.

The composition of Example 12 was subjected to the UL-94 Vertical Burn test in which a flame is applied to the free end of a 120 mm×12 mm sample. The sample was self-extinguishing with a flaming time (average t1) of 2.6 seconds and did not exhibit dripping (UL-94 V0 rating at 1.5 mm).

The composition of Example 12 was also analysed by cone calorimetry (ISO 5660 Part 1).

### COMPARATIVE EXAMPLES

Example 12 was repeated replacing the methoxy benzoxazine silane and KSS by: C2—reference sample with no additive (neat polycarbonate)

Example 12 was repeated removing the methoxy benzoxazine silane (C3).

These samples were subjected to the UL-94 Vertical Burn test, as well, and presented longer flaming times (average t1 of 11.2 seconds for C2 and 4.4 seconds for C3) and dripping with ignition of the cotton placed below the sample and, therefore, a UL-94 V2 rating.

These samples were also analysed by Cone calorimetry and compared with sample of Example 12. This latter sample presents a lower peak of heat release rate compared to the reference sample C2, or C3.

The benzoxazine silanes were found to be excellent synergists with KSS, the typical FR benchmark for PC: besides not degrading the impact resistance, the methoxy benzoxazine silane led to a decrease by 18% in the peak of heat release rate (pHRR), and to a UL-94 V0 classification, when added at 0.65 wt % together with KSS. This latter one (sample C3), by itself, cannot enable a V0 rating, except if the fluorine-based compounds (e.g. PTFE) were added as anti-dripping agents. Therefore, this approach can replace the use of PTFE and we could claim a 100% halogen-free FR additive.

1. A process for improving the fire resistance of a thermoplastic, thermoset or rubber organic polymer composition, wherein an alkoxysilane of the formula 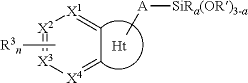
where X¹, X², X³ and X⁴ independently represent a CH group or a N atom and form a benzene, pyridine, pyridazine, pyrazine, pyrimidine or triazine aromatic ring and Ht represents a heterocyclic ring fused to the aromatic ring and comprising 2 to 8 carbon atoms, 1 to 4 nitrogen atoms and optionally 1 or 2 oxygen and/or sulphur atoms; A represents a divalent organic linkage having 1 to 20 carbon atoms bonded to a nitrogen atom of the heterocyclic ring; each R represents an alkyl, cycloalkyl, alkenyl, alkynyl, aryl, aminoalkyl or aminoaryl group having 1 to 20 carbon atoms; each R′ represents an alkyl group having 1 to 4 carbon atoms; a is 0, 1 or 2; the heterocyclic ring can optionally have one or more substituent groups selected from alkyl, substituted alkyl, cycloalkyl, alkenyl, alkynyl, aryl and substituted aryl groups having 1 to 12 carbon atoms and amino, nitrile, amido and imido groups; and R³ₙ, with n=0-4, represents an alkyl, substituted alkyl, alkenyl group having 1 to 8 carbon atoms or cycloalkyl, alkynyl, aryl, substituted aryl groups having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, substituted on one or more positions of the aromatic ring, or two groups R³ can be joined to form a ring system comprising at least one carbocyclic or heterocyclic ring fused to the aromatic ring is added to a thermoplastic, thermosetting and rubber organic polymer composition and is heated to cause hydrolysis and condensation of the alkoxysilane.

2. (canceled)

3. A polymer composition comprising a thermoplastic, thermosetting or rubber organic polymer and an alkoxysilane, or its hydrolyzate, condensate or partially hydrolyzate/condensate species of the formula 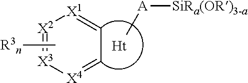
where X¹, X², X³ and X⁴ independently represent a CH group or a N atom and form a benzene, pyridine, pyridazine, pyrazine, pyrimidine or triazine aromatic ring and Ht represents a heterocyclic ring fused to the aromatic ring and comprising 2 to 8 carbon atoms, 1 to 4 nitrogen atoms and optionally 1 or 2 oxygen and/or sulphur atoms; A represents a divalent organic linkage having 1 to 20 carbon atoms bonded to a nitrogen atom of the heterocyclic ring; each R represents an alkyl, cycloalkyl, alkenyl, alkynyl, aryl, aminoalkyl or aminoaryl group having 1 to 20 carbon atoms; each R′ represents an alkyl group having 1 to 4 carbon atoms; a is 0, 1 or 2; the heterocyclic ring can optionally have one or more substituent groups selected from alkyl, substituted alkyl, cycloalkyl, alkenyl, alkynyl, aryl and substituted aryl groups having 1 to 12 carbon atoms and amino, nitrile, amido and imido groups; and R³ₙ, with n=0-4, represents an alkyl, substituted alkyl, alkenyl group having 1 to 8 carbon atoms or cycloalkyl, alkynyl, aryl, substituted aryl groups having 1 to 40 carbon atoms, or an amino, nitrile, amido or imido group, or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, substituted on one or more positions of the aromatic ring, or two groups R³ can be joined to form a ring system comprising at least one carbocyclic or heterocyclic ring fused to the aromatic ring.

4. The polymer composition according to claim 3, wherein the alkoxysilane has the formula 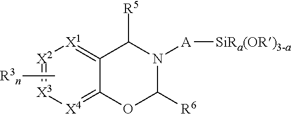
where R⁵ and R⁶ each represent hydrogen, an alkyl, substituted alkyl, cycloalkyl, alkenyl, alkynyl, aryl or substituted aryl group having 1 to 12 carbon atoms, or an amino or nitrile group.

5. The polymer composition according to claim 4, wherein the alkoxysilane has the formula 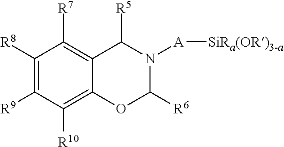
where R⁷, R⁸, R⁹ and R¹⁰ each represent hydrogen, an alkyl, substituted alkyl, alkenyl group having 1 to 8 carbon atoms or a cycloalkyl, alkynyl, aryl, substituted aryl group having 1 to 40 carbon atoms, or an amino, nitrile, amido or imido group, or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, or R⁷ and R⁸, R⁸ and R⁹ or R⁹ and R¹⁰ can each be joined to form a ring system comprising at least one carbocyclic or heterocyclic ring fused to the benzene ring.

6. The polymer composition according to claim 5, wherein the groups R⁷ and R⁸, R⁸ and R⁹ or R⁹ and R¹⁰ form an annelated ring of benzoquinoid or naphthoquinoid structure.

7. The polymer composition according to claim 3, wherein the alkoxysilane is a trialkoxysilane of the formula

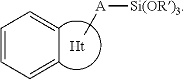

8. The polymer composition according to claim 3, wherein the alkoxysilane is a bissilane containing two heterocyclic rings each having an alkoxysilane substituent.

9. The polymer composition according to claim 5, wherein the alkoxysilane has the formula 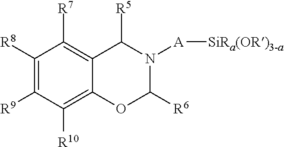
where A, R, R′ and a are each defined as above; R⁵ and R⁶ are each hydrogen, an alkyl, substituted alkyl, cycloalkyl, alkenyl, alkynyl, aryl or substituted aryl group having 1 to 12 carbon atoms, or an amino or nitrile group; one group selected from R⁷, R⁸, R⁹ and R¹⁰ represents an alkyl group substituted by a group of the formula 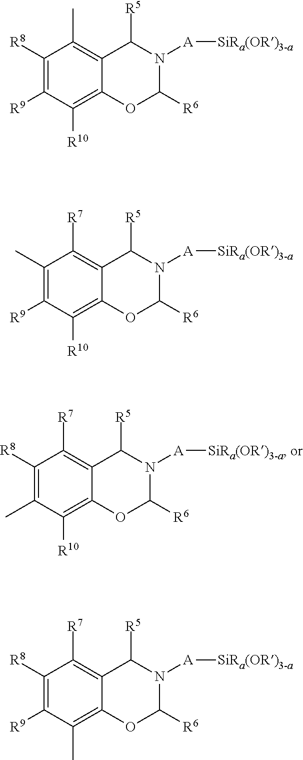
where A, R⁵ and R⁶ are defined as above; and the remaining groups of R⁷, R⁸, R⁹ and R¹⁰ on each ring each represent hydrogen, an alkyl, substituted alkyl, alkenyl group having 1 to 8 carbon atoms or a cycloalkyl, alkynyl, aryl, substituted aryl group having 1 to 40 carbon atoms, or an amino, nitrile, amido or imido group, or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms.

10. The polymer composition according to claim 4, wherein the aromatic ring Ar of the alkoxysilane is annelated to another aromatic ring to form a naphthalene or quinoline ring system, and two heterocyclic rings Ht, each having a -A-SiRₐ(OR′)₃₋ₐ substituent, are fused to the same ring or separate rings of the naphthalene or quinoline ring system.

11. The polymer composition according to claim 5, wherein the alkoxysilane is a bissilane in which the groups R⁷ and R⁸, R⁸ and R⁹ or R⁹ and R¹⁰ form a naphthoquinoid structure and a second heterocyclic ring Ht is attached either to the aromatic ring Ar or to the second aromatic ring of the naphthoquinoid structure.

12. The polymer composition according to claim 3, wherein the composition also contains a tetraalkoxysilane of the formula Si(OR′)₄ and/or a trialkoxysilane of the formula R₂Si(OR′)₃, where each R′ is an alkyl group having 1 to 4 carbon atoms and R₂ is an alkyl, cycloalkyl, alkenyl, alkynyl or aryl group having 1 to 20 carbon atoms

13. The polymer composition according to claim 3, wherein the thermoplastic organic polymer comprises a polycarbonate or a blend of polycarbonate with another organic polymer.

14. The polymer composition according to claim 3, wherein the composition contains a filler.

15. The polymer composition according to claim 14 which is treated with the alkoxysilane.

16. The polymer composition according to claim 3 wherein the composition contains a silica filler.

17. The polymer composition according to claim 3 wherein the composition also comprises a polydiorganosiloxane gum.

18. The polymer composition according to claim 16 wherein the silica is coated with a polydiorganosiloxane gum.

19. The polymer composition according to claim 3 wherein the composition contains another flame retardant additive.
